(19) United States
(12) Patent Application Publication
(10) Pub. No.: US 2010/0062132 A1
(43) Pub. Date: Mar. 11, 2010

(54) SEMISOLID FOOD PRODUCT COMPOSITION AND PRODUCTION PROCESS

(75) Inventor: Ricardo Alberto Madrigal Overhage, Apodaca (MX)

Correspondence Address: Glast, Phillips & Murray, P.C, 13355 Noel Road, Suite 2200, Dallas, TX, 75240, US

(73) Assignee: PROVEEDORES DE INGENIERIA ALIMENTARIA. S.A. DE C.V., Apodaca (MX)

(21) Appl. No.: 12/260,388

(22) Filed: Oct. 29, 2008

(30) Foreign Application Priority Data
Sep. 9, 2008 (MX) MX/A/2008/011515

(51) Int. Cl. A23L 1/212

(52) U.S. Cl. 426/541; 426/615

(57) ABSTRACT

This disclosure relates to processed food products, and more specifically, it relates to an avocado or guacamole emulsion having a semisolid structure, characterized by a pasty structure, substantially solid, in sliceable bars or cakes, or in individual slices that includes: avocado pulp, water, hydrocolloids, alginates, emulsifiers, enzyme inhibitors, antioxidants, preservatives and a demoisturizer in certain proportions, and which may also include proteins, citric acid, lemon powder, flavors and salt in certain proportions.

### CLAIM FOR PRIORITY

This application claims the priority of Mexican Patent Application, serial no. MX/a/2008/011515, filed Sep. 9, 2008, having the title “Composición mehorada de producto alimenticio sempostoso y proceso de elaboración,” which application is incorporated by reference into the present application.

### BACKGROUND

1. Technical Field

This disclosure relates to processed food products; in particular to compositions of a semisolid avocado food product and methods for making same.

2. Background Art

It is widely known among the food industry that an endless number of processed, ready-to-eat products have been developed for the end consumer. The nutritional valued provided by the avocado is also widely known. The avocado is made up of about 70% water, 2% proteins, 21% fat, 6% carbohydrates and about 1% minerals. It also contains vitamins A and B, cystine, tyrosine and tryptophan, which makes the avocado a wholesome food of high digestibility.

The avocado can be consumed without processing, that is, like a fruit that is usually served with foods, like an appetizer and as an important ingredient of several dishes. The problem present with the non-processed avocado is its availability depending on the season of the year, its fluctuating selling prices, and the difficulty of obtaining it since it is not sold everywhere. Also, it is a food product that due to its composition and structure, requires cutting devices or other machines to slice it and peel it, and it is also a climacteric and perishable product. The avocado has a short shelf life due to the accelerated oxidation it suffers, from the time it is harvested, and once it is opened or sliced.

The avocado can also be processed, for example, as dehydrated avocado; however, the organoleptic, nutritional and physical properties are affected during the dehydration process, besides being an expensive process.

Another way of commercializing and consuming avocados is through a freezing process, whole or in slices and vacuum-packed; however, it is an expensive product due to the high-costs of its processing, and it has limited availability because most of it is produced for its exporting.

Another popular form is what is known as guacamole, which is a kind of thick sauce whose main ingredient is avocado along with other ingredients, such as onion, tomato and chili; some spices and oils can be included. Guacamole is a watery product, with a somewhat thick texture, and it is generally prepared as a side sauce for other dishes; however, it is a product consumed on the spot since its organoleptic characteristics and appearance are easily altered within a period of time due to its accelerated oxidation.

Guacamole can be commercialized fresh, or frozen and packaged; however, due to its physical properties, it needs to be packaged in specific cans or containers for watery products. It is necessary to keep it frozen during its shelving, and once it reaches the final consumer, it has to be consumed once it is open since it suffers the same problem of accelerated oxidation.

Therefore, having an improved composition of an avocado-based, semisolid food product with a longer shelf-life, before and after its consumption, readily available anywhere throughout the year, and easier to handle by the end consumer, would be greatly advantageous, highly competitive and with a great commercial and consumer impact, when compared to similar products currently on the market.

It would be desirable to have a method of making an avocado-based, semisolid food product, with texture and viscosity characteristics that would allow it to be sliced or cut into portions, and to be spread or used with other food products, while retaining desirable organoleptic properties.

It would also be desirable to make an avocado-based, semisolid food product, with a longer shelf life, is available throughout the year, and that it can systematically be consumed without having its physical and organoleptic properties affected.

### DETAILED DESCRIPTION

Considering the necessity of new food products that a allow greater conservation, with a longer shelf life, and that are easier to handle during their production, distribution and consumption, and considering an improved composition of a semisolid food product whose main ingredient is avocado, the idea of an avocado-based product convenient for the end consumer was developed. A search for a new formula was begun to also determine ingredients suitable for the desired final characteristics: an avocado or guacamole emulsion with a semisolid structure that can be sliced, with a good palatableness and pleasant taste, among other physical and organoleptic properties.

Several problems arose, such as the fact that by using certain products or agents, the product's final characteristics left a very unpleasant aftertaste; therefore, the formula was being modified to diminish that unpleasant taste and to obtain a characteristic taste without the added agents losing their intended functional properties.

One of the product's main characteristics is its texture and firmness since it is a semisolid avocado or guacamole composition. It should be sufficiently firm to be sliced without sticking to the slicing blades, without a viscous consistency, and able to be contained in individually packed portions. In order to achieve these characteristics, research studies using several possible ingredients were carried out.

After multiple studies and tests, the composition shown in the following Table 1 was found to be meet these requirements.

TABLE 1

| Ingredients | % by weight |
|---|---|
| Avocado pulp | From 65 to 75 |
| Water | From 15 to 25 |
| Hydrocolloids | From 3 to 8 |
| Alginates | From 3 to 6 |
| Emulsifier | From 0.1 to 0.3 |
| Nitrogen gas | Less than 1 (by volume) |
| Oxygen absorbing enzymes | Less than 0.5 |
| Enzymes inhibitor | Less than 20 (ppm) |
| Antioxidant | From 0.01 to 0.5 |
| Preservative | From 0.15 to 1.5 |
| Demoisturizer | From 0.1 to 0.5 |

The composition shown in Table 1 preferably also includes animal and dairy proteins between about 0.1% to 0.3%. The proteins preferably comprise collagen and whey protein, respectively.

The composition preferably also includes an acid (ascorbic acid or other similar acids) in between about 0.2% to 0.5% in order to provide acidity to the product, and powdered lemon between about 0.2% and 0.5% to add an acid taste.

The composition can also include flavors in between about 0.2% to 0.5%, and salt in between about 1% and 2%, and spices in between about 1 to 5%.

The demoisturizer (typically silica, or silicon dioxide) is used to keep the power mix from clumping together, thus allowing stopping of a production unit without causing processing problems afterwards due to an improper dispersion of the additives.

Alginates are a purified chemical substance, obtained from brown sea algae and used in the mix as a stabilizer.

The antioxidants used are picked from the group consisting of butylated hydroxyanisole (BHA), butylated hydroxytoluene (BHT), teriary butylhydroquinone (TBHQ), rosemary oil, or a mix of some or all of them.

The preservatives used are picked from the group consisting of benzoate, sorbate, propionate, paraben, acetate, lactate, or a mix of some, or all of them.

The hydrocolloids are picked from the group that consists of gelatin, pectin, carragenin, agar, alginate, guar gum, gum arabic, tragacanth gum, gatti, starch, modified starch, xanthan gum, carboxymethylcellulose (CMC), or a mix of some or all of them.

The enzyme inhibitors are molecules that attach themselves to enzymes to reduce their activity; this slows down the enzymatic darkening in the product by inhibiting the specific enzymes (peroxidase, phenolase, or polyphenol oxidase) present in the avocado's pulp. Some of the inhibitors that can be used are sodium sulfite, ascorbic acid, or the combination of both.

A suitable oxygen-absorbing enzyme is glucose oxidase. A suitable emulsifier is lecithin, collagen or sodium sterol lactate, or a mix of some or all of them.

The aforementioned composition provides the food product with the desired characteristics. The food product could be produced in bars that can later be sliced without losing their original form, without sticking to the slicing device, and flexible enough to keep from breaking apart while being sliced. The product provides the sensation of eating a natural avocado and has adequate texture to be packed individually in portioned packages.

The product can be sold in bars to be sliced when needed, or it can be sold in individually packed slices, In both cases, a controlled or modified-atmosphere package (containing a gas such as nitrogen) may be used, or an oxygen-free vacuum sealed package may be used. The product can also be used as an avocado cake or an avocado emulsion that can be sliced, or in slices.

The production process for the described improved composition of a semisolid food product may include generally the following steps: (a) mixing the salt and liquid ingredients, (b) adding a portion of the demoisturizer until homogenization is obtained, (c) adding a portion of ground spices with another portion of the demoisturizer, (d) adding hydrocolloids and the animal and dairy proteins, (e) mixing, and (f) adding the remaining ground spices and the remaining demoisturizer; (g) adding the avocado pulp; (h) adding the emulsifying agent; (i) adding water; (j) adding condiments and the alginates; mixing continuously until obtaining a homogenous mix, (k) adding the preservatives and antioxidants, (l) adding the oxygen, peroxidase, phenolase, and polyphenol oxidase-absorbing enzymes, (m) mixing until obtaining a homogenous mix, (n) forming a solid avocado or guacamole bar, (o) adding nitrogen to the emulsion, (p) packing in a controlled or modified atmosphere, or with a vacuum seal, and (q) refrigerating.

The procedure can include, after forming a solid avocado bar at step (n) above, slicing the solid avocado, following the indicated steps for packing and refrigerating individual slices.

The processing time to obtain the aforementioned avocado or guacamole product is less than 10 minutes.

Since those skilled in the art can modify the specific embodiments described above, I intend that the claims be interpreted to cover such modifications and equivalents. The claimed “avocado composition” includes, of course, guacamole, as well as avocado alone. Further, in the claims, I intend for “a” or “an” to refer to one or more.

I claim:

1. An avocado composition, comprising:
avocado pulp, water, a hydrocolloid, an alginate, an emulsifier, an enzyme inhibiter, an antioxidant, a preservative, and a demositurizer.

2. The avocado composition of claim 1 where the amount of avocado pulp by weight is between about 65% and 75% of the avocado composition.

3. The avocado composition of claim 1 where the amount of water by weight is between about 15% and 25% of the avocado composition.

4. The avocado composition of claim 1 where the amount of hydrocolloid by weight is between about 3% and 8% of the avocado composition.

5. The avocado composition of claim 1, where the hydrocolloid is gelatin, pectin, carrageen, agar, alginate, guar gum, gum arabic, tragacanth gum, gatti, starch, modified starch, xanthan gum, or CMC.

6. The avocado composition of claim 1 where the amount of alginate is between about 3% and 6% of the avocado composition.

7. The avocado composition of claim 1, further comprising a composition of animal and dairy protein.

8. The avocado composition of claim 7, where the composition of animal and dairy protein comprises collagen and whey protein.

9. The avocado composition of claim 7, where the amount of the composition of the animal and dairy protein by weight is between about 0.2% and 0.7% of the avocado composition.

10. The avocado composition of claim 1, where the amount by weight of the emulsifier is between about 0.1% to 0.3%; where the amount by weight of the enzyme inhibitor is about 20 parts per million; where the amount by weight of the antioxidant is between about 0.01% and 0.5%; where the amount by weight of the preservative is between about 0.15% and 1.5%; and the amount of the demoisturizer is between about 0.1% and 0.5%.

11. The avocado composition of claim 1, where the enzyme inhibitor is sodium sulfite or ascorbic acid.

12. The avocado composition of claim 11, where the antioxidant is BHA, BHT, TBHQ, or rosemary oil.

13. The avocado composition of claim 1, where the preservative is benzoate, sorbate, propionate, paraben, acetate, or lactate.

14. The avocado composition of claim 1, further comprising an acid in an amount by weight of between about 0.2% and 0.5% of the avocado composition.

15. The avocado composition of claim 1, further comprising salt in an amount by weight of between about 1% to 2% of the avocado composition.

16. An avocado composition comprising, by weight:
avocado pulp, in an amount between about 65% to 75%;
water, in an amount between about 15% and 25%;
a hydrocolloid, in an amount between about 3% to 8%;
an alginate, in an amount between about 3% to 6%;
an emulsifier, in an amount between about 0.1% to 0.3%;
an enzyme inhibiter, in the amount of about 20 parts per million;
an antioxidant, in an amount between about 0.01% to 0.5%;
a preservative, in an amount between about 0. 15% to 1.5%; and,
a protein composition, in an amount between about 0.1% to 0.3%.

17. The avocado composition of claim 16 above, further comprising, by weight:
ascorbic acid, in an amount between about 0.2% and 0.5%;
salt, in amount between about 1% and 2%; and,
spices, in an amount between about 1% and 5%.

18. A process for making an avocado composition, comprising:
mixing salt and liquid ingredients;
adding a portion of demoisturizer until a homogenization is obtained;
adding avocado pulp;
adding an emulsifying agent;
adding water;
adding condiments and alginates;
mixing continuously until obtaining a homogenous mix;
adding preservatives and antioxidants;
adding oxygen-absorbing enzymes;
mixing until obtaining a homogenous mix; and,
forming a semisolid bar from the mix.

19. The process for making an avocado composition of claim 18, further comprising:
adding a portion of ground spices with another portion of demoisturizer;
adding hydrocolloids and animal and dairy proteins;
mixing; and,
adding the remaining ground spices and the remaining demoisturizer.

20. The process for making an avocado composition of claim 18, further comprising:
adding nitrogen gas to the mix; and,
slicing the semisolid bar and packing it in individual slices.
